(19) United States
(12) Patent Application Publication
(10) Pub. No.: US 2026/0101366 A1
(43) Pub. Date: Apr. 9, 2026

(54) HOST SYSTEM AND METHOD OF ENFORCING QUALITY OF SERVICE REQUIREMENTS FOR WIFI SENSING APPLICATIONS

(71) Applicant: GM GLOBAL TECHNOLOGY OPERATIONS LLC, Detroit, MI (US)

(72) Inventors: Kamran Ali, Troy, MI (US); Lakshmi V Thanayankizil, Rochester Hills, MI (US); Haneya Qureshi, Troy, MI (US)

(73) Assignee: GM GLOBAL TECHNOLOGY OPERATIONS LLC, Detroit, MI (US)

(21) Appl. No.: 18/910,308

(22) Filed: Oct. 9, 2024

(51) Int. Cl. H04W 72/566; H04W 84/12

(52) U.S. Cl. CPC H04W 72/569; H04W 84/12

(57) ABSTRACT

A method for enforcing Quality of Service (QoS) requirements in a WiFi communication network of a vehicle or another host system having one or more wireless sensors, i.e., WiFi or WiFi-enabled sensors, includes detecting wireless traffic on one or more channels of the network, as detected WiFi traffic, using a central coordinator (CC_{O}) node of the network. The method includes identifying an access category (AC) of the detected traffic as corresponding to sensing traffic, i.e., sensing operations of the wireless sensors. The CC_{O} node assigns a higher priority to WiFi sensing traffic relative to other wireless traffic on the channel(s). Modification may be made to one or more QoS parameters, including an arbitrary inter-frame space number (AIFSN), contention window (CW) size, transmit opportunity (TXOP) value, and/or respective threshold of a request-to-send (RTS) frame and a clear-to-send (CTS) frame for the detected sensing traffic.

### INTRODUCTION

Smartphones and other mobile devices are used for accessing communication, entertainment, and information applications. IEEE 802.11 is the wireless fidelity standard that outlines basic architecture and physical layer specifications for the operation of wireless local area networks (WLANs). Using the WiFi standard, nodes of a WLAN are able to communicate wirelessly using high-frequency radio waves and communication channels that overlap in frequency. Aboard a host system in the form of a vehicle, for example, WiFi enables a myriad of useful applications such as hands-free calling, enhanced navigation, real-time traffic and weather reports, satellite music, data streaming, software updates, sensing, and access to emergency services. Some vehicles use a WiFi network to transmit information to and receive information from a remote call center or back office, as well as to communicate between different internet-connectable devices within the vehicle. Communication may occur through various wireless access points (APs) situated along the vehicle's travel route, with an onboard wireless control module scanning for available wireless APs on different WiFi channels.

Quality of Service (QoS) refers to the description or measurement of the overall performance of a given application, for instance telephony or network connectivity. Under IEEE 802.11c, Enhanced Distributed Channel Access (EDCA) currently defines four separate QoS categories for managing WiFi traffic: (1) voice traffic, (2) video traffic, (3) best effort traffic, and (4) background traffic. A different priority is assigned to each of these categories to ultimately determine how often and for how long a given WiFi device is permitted to transmit data on a given channel. Voice traffic is assigned the highest priority and the shortest contention window (CW), meaning voice functions are allowed to access a WiFi channel more frequently and with less delay than other functions. The video category has the second highest priority and a slightly longer CW than voice. This is followed by best effort, which covers functions such as web browsing and streaming traffic. Of the four defined categories, background has the lowest priority and the longest CW, and thus is relegated to communication of low-priority traffic, or traffic that is not time-sensitive, e.g., email or file transfer operations.

### SUMMARY

The technical solutions proposed herein enable, in contrast to the current state of the art, the automated application-aware prioritization of WiFi sensing traffic in a wireless network. In particular, the present solutions are intended for applications in which WiFi sensing operations aboard a vehicle or another host system compete with WiFi communication for available spectrum. The disclosed approach contemplates adding a fifth Quality of Service (QoS) category—WiFi Sensing—to the above-summarized QoS categories, along with associated rules for precisely when and how to treat WiFi sensing traffic relative to data falling into the remaining four categories. WiFi sensing traffic is then selectively prioritized based on requirements of the particular sensing application in one or more embodiments.

In particular, a method is disclosed herein for coordinating operation of a WiFi communication network aboard a host system having one or more wireless sensors. The one or more wireless sensors including WiFi sensors and/or WiFi-enabled sensors. An embodiment of the method includes detecting wireless traffic (as detected WiFi traffic). This action may be performed using a central coordinator (CC_{O}) node of the WiFi communication network, with the wireless traffic occurring between a plurality of WiFi nodes on one or more channels of the WiFi communication network. The WiFi nodes include the wireless sensor(s). The method includes identifying an access category (AC) of the detected WiFi traffic as corresponding to sensing traffic, with the sensing traffic including wireless sensing operations of the one or more wireless sensors. Additionally, the method includes assigning a higher priority to the sensing traffic relative to other wireless traffic on the one or more channels of the WiFi communication network, and thereafter coordinating network communication between the plurality of WiFi nodes in accordance with the higher priority.

Assigning the higher priority to the sensing traffic relative to other wireless traffic may include adapting or modifying one or more QoS parameters of at least the sensing traffic. In different embodiments, the action of adapting or modifying the QoS parameter(s) may include adapting or modifying an arbitrary inter-frame space number (AIFSN), a contention window (CW) size, a transmit opportunity (TXOP) value, and/or a respective threshold of a request-to-send (RTS) frame and a clear-to-send (CTS) frame.

Assigning the higher priority may also include lowering a communication priority of one or more of voice traffic, video traffic, best effort traffic, or background traffic. This action may optionally include assigning a priority to the voice traffic, the video traffic, and the best effort traffic to match a priority level of the background traffic. In this or other implementations, assigning the higher priority to the WiFi sensing traffic may be based at least in part on a number of devices that are using the WiFi communication network, e.g., by adjusting one or more QoS parameters in proportion to the number of devices that are using the WiFi communication network.

In some implementations of the method, the AC of the detected WiFi traffic includes detecting one or more bits in the detected WiFi traffic that correspond to the AC.

The method may further include sensing a value in the host system, as a sensed value, using the one or more WiFi sensor, and also transmitting the sensed value to the CC_{O} node as part of the WiFi sensing operation.

Also described herein is a WiFi communication network having a plurality of WiFi nodes and a central coordinator (CC_{O}) node. The WiFi nodes are operable for generating wireless communication traffic and include at least one wireless sensor, i.e., a WiFi sensor and/or a WiFi-enabled sensor. The CC_{O} node, which is in wireless communication with each respective one of the WiFi nodes, is configured to detect the wireless traffic on one or more channels of the WiFi communication network as detected WiFi traffic. The CC_{O} node also identifies a QoS AC of the detected WiFi traffic as corresponding to sensing traffic from the at least one wireless sensor. The sensing traffic corresponds to WiFi sensing operations of one or more of the WiFi nodes. The CC_{O} node is also configured to assign a higher priority to the sensing traffic relative to other wireless traffic on the one or more channels, and to coordinate WiFi communication between the plurality of WiFi nodes in accordance with the higher priority.

An aspect of the disclosure includes a vehicle having one or more/a set of road wheels connected to the vehicle body, and a propulsion system connected to one or more of the road wheels. The vehicle also includes a WiFi communication network. The WiFi communication network in accordance with one or more implementations includes a plurality of WiFi nodes operable for generating wireless traffic. Such WiFi nodes include at least one wireless sensor, which as noted above includes a WiFi sensor and/or a WiFi-enabled sensor.

The network further includes a CC_{O} node in wireless communication with each respective one of the WiFi nodes. The CC_{O} node is configured to detect the wireless traffic on one or more channels of the WiFi communication network as detected WiFi traffic, and to thereafter identify a QoS AC of the detected WiFi traffic as corresponding to sensing traffic from the at least one wireless sensor. The sensing traffic corresponds to WiFi sensing operations of one or more of the WiFi nodes. The CC_{O} node is configured to assign a higher priority to the sensing traffic relative to other wireless traffic on the one or more channels by adapting or modifying one or more QoS parameters of the sensing traffic. The QoS parameters include an arbitrary AIFSN, a CW size, a TXOP value, and a respective threshold of an RTS frame and a CTS frame. The CC_{O} node in this embodiment then coordinates network communication between the plurality of WiFi nodes in accordance with the higher priority.

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

FIG. 1 is an illustration of a host system in the form of a representative vehicle having a WiFi communication system constructed as set forth herein.

FIG. 2 is a simplified network diagram describing an aspect of the WiFi communication system shown in FIG. 1.

FIG. 3 is a flow chart illustrating a method for selectively prioritizing WiFi sensing traffic in accordance with an embodiment.

FIG. 4 is a table illustrating a possible implementation of a sensing Quality of Service (QoS) category as part of the method shown in FIG. 3.

The present disclosure may be modified or embodied in alternative forms, with representative embodiments shown in the drawings and described in detail below. Inventive aspects of the present disclosure are not limited to the disclosed embodiments. Rather, the present disclosure is intended to cover alternatives falling within the scope of the disclosure as defined by the appended claims.

### DETAILED DESCRIPTION

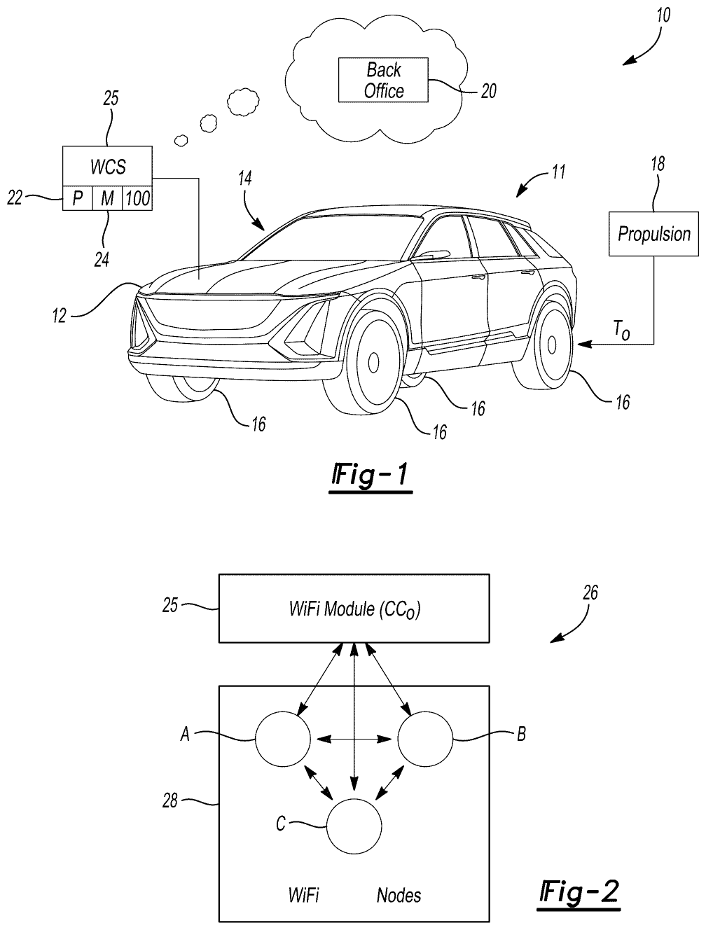

Referring to the drawings, wherein like reference numbers refer to like features throughout the several views, FIG. 1 illustrates a host system 10 having a WiFi communications system (WCS) 25 constructed as described below. The host system 10 may be optionally embodied as a representative vehicle 11 having a vehicle body 12 defining a vehicle interior 14. The vehicle 11 may be variously constructed as a passenger vehicle having a set of road wheels 16, e.g., four road wheels 16 as shown, and a propulsion system 18. The propulsion system 18 may include an internal combustion engine and/or one or more electric traction motors (not shown) in different embodiments. The propulsion system 18 is operable for generating and outputting torque (To) to one or more of the road wheels 16 to propel the vehicle 11.

In other possible configurations, the vehicle 11 of FIG. 1 may be constructed as an aircraft, spacecraft, motorcycle, train/rail vehicle, boat/marine vessel, etc., although the present teachings are not limited to vehicular or mobile use. For instance, the host system 10 of FIG. 1 may encompass a home, office, or other stationary environment such that the present teachings may be applied more broadly to the internet of things (IoT). The below descriptions and representative examples refer to the vehicle 11 of FIG. 1 solely for illustrative consistency and clarity.

The WCS 25 may be in wireless/remote communication with a remotely located back office node 20, e.g., a cloud-based service, a subscription-based communications, security, emergency, navigation, and diagnostics service such as ONSTAR®, etc. To that end, the WCS 25 may be configured as a vehicle telecommunications and information (“telematics”) unit or TCU that wirelessly communicates with the back office node 20, e.g., via a cellular network, satellite service, wireless or wireless-enabled modem, etc., The WCS 25 includes hardware in the form of one or more Application Specific Integrated Circuit(s) (ASIC), Field-Programmable Gate Array (FPGA), electronic circuit(s), central processing unit(s), e.g., microprocessor(s) or processors (P) 22, and associated computer readable storage medium/memory 24.

Instructions embodying a method 100 (an example of which is described below with reference to FIG. 3) are executed from the memory (M) 24, for instance magnetic or optical media, CD-ROM, and/or solid-state/semiconductor memory (e.g., various RAM or ROM). Non-transitory components of the memory 24 used herein are capable of storing machine-readable instructions in the form of one or more software or firmware programs or routines, combinational logic circuit(s), input/output circuit(s) and devices, signal conditioning and buffer circuitry and other components that can be accessed by one or more processors to provide a described functionality.

WiFi Sensing Prioritization: Within the scope of the disclosure, the WCS 25 prioritized WiFi sensing traffic over other WiFi traffic. As appreciated in the art, the current WiFi Multi-Media (WMM) 802.11e feature is intended to enforce Quality of Service (QoS) requirements. WMM is a particular set of features that enable WiFi devices to communicate their QoS requirements to a WiFi router, e.g., the WCS 25 of FIG. 1, and that enable the WiFi router to optimally allocate available bandwidth and channel access. This occurs for the four access categories or ACs noted above, i.e., voice, video, best effort, and background. As an improvement to basic enhanced distributed channel access (EDCA)/WMM, WMM admission control also allows devices to request a “guaranteed” amount of latency and bandwidth for certain applications. As contemplated herein, the proposed addition of a fifth QoS category, that of WiFi sensing, would enable continued use of WMM as an effective mechanism for achieving guaranteed bandwidth for WiFi sensing operations.

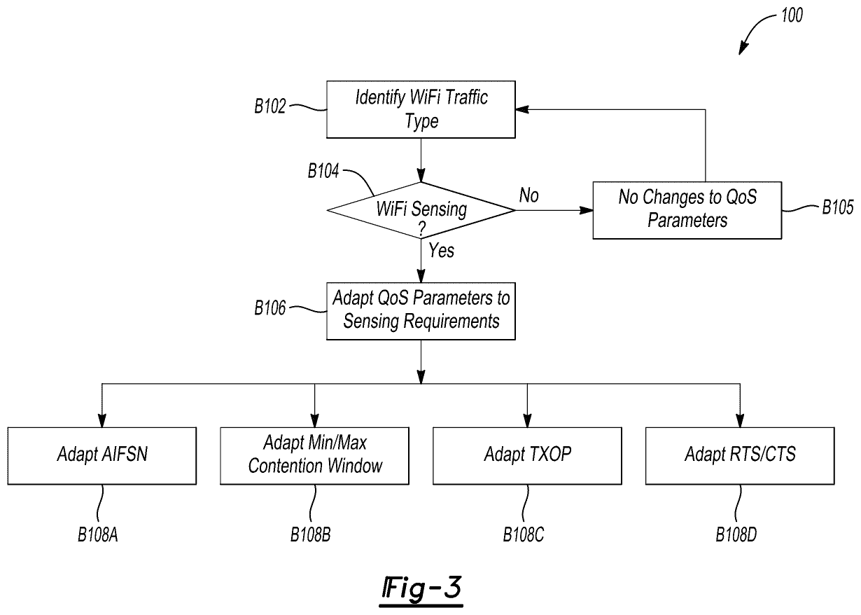

Referring briefly to FIG. 2, implementation of WiFi sensing operations onboard the host system 10 of FIG. 1 is illustrated schematically as an exemplary wireless communication network 26 in which the WCS 25 act as a main WiFi module or central coordinator (CC_{O}) node, i.e., one that coordinates the actions of the network. In other implementations, the disclosed actions of such a CC_{O} node may be distributed, e.g., the QoS adaptations described below are pre-programmed or configured in WiFi devices/nodes, and from then onwards such devices/nodes may make the various disclosed QoS decisions or adaptations. That is, it is possible that the WCS 25/CC_{O} node shares information with other WiFi devices in the network, which in turn make QoS decisions/take QoS prioritization actions based on this information and how that particular node locally perceives the communication channel environment, e.g., congestion, etc. Operation via the WCS 25 will be described hereinafter for illustrative consistency without limiting applications to such an implementation.

The WCS 25/CC_{O} node is in wireless communication with a distributed set of WiFi nodes 28, one or more of which may be wireless sensing nodes and others of which may perform functions other than sensing. For illustrative simplicity, three sensor nodes are nominally labeled A, B, and C in the simplified mesh arrangement of FIG. 2. The actual number of WiFi nodes 28 in a given implementation of the wireless communication network 26 would vary with the application and the construction of the host system 10, as appreciated in the art. Representative embodiments of the WiFi nodes 28 constructed as wireless sensors may include respiration sensors, heart rate sensors, or other high-frequency biological sensors or occupant detection sensors. A typical embodiment of the vehicle 11 may also incorporate various other WiFi sensors, e.g., tire pressure sensors, wireless climate or air quality sensors, driver attention/drowsiness sensors such as eye tracking, seat position sensors, wireless backup cameras, WiFi microphones, etc.

As appreciated by those skilled in the art, a distinction is ordinarily made between a WiFi-enabled sensor and WiFi sensing. Wireless sensing as contemplated herein may be of either type. A WiFi-enabled sensor is one that is connected to a WiFi communication capability, with its sensor values read and communicated via WiFi channels. WiFi sensing for its part operates like a radar sensor by leveraging the WiFi communication signals themselves whenever two WiFi nodes are communicating with each other. For example, if a person is breathing near two WiFi nodes that are communicating with each other, the two nodes are able to leverage the channel state information (CSI) in the communicated WiFi packets to determine a breathing rate. The present teachings apply primarily to WiFi sensing and the prioritization of WiFi sensing traffic, but may also be applied to the realm of WiFi-enabled sensors, as will be appreciated by those skilled in the art.

In the wireless communication network 26 of FIG. 2, the WCS 25 acting as the above-noted CC_{O} node may initiate sensing instances or “rounds”. Each sensing round involves communication between the various pairs of WiFi nodes 28 acting as wireless sensors in the wireless communication network 26, i.e., WiFi nodes 28 that participate in a given sensing action. For example, the sensor nodes 28 may correspond to a set of respiration sensors arranged within the vehicle interior 14 of FIG. 1 and collectively configured to detect respiration, and thus the possible presence of an occupant, with other sensors not participating in sensing of respiration/breathing not being party to the illustrative sensing event in this instance. Once the sensing round has finished, collected data is transferred to the WCS 25 for final signal processing to enable an associated application or function, or occupant/child detection in this exemplary scenario. Sensing should finish twice as fast as the frequency of the sensed activity, e.g., breathing, so as to meet the Nyquist sampling criteria, as appreciated in the art. Thus, the implementations described herein may include sensing a value in the host system 10, i.e., as a sensed value, using the one or more WiFi sensors present in the WiFi nodes 28, and then transmitting the sensed value to the WCS 25/CC_{O} node as part of the disclosed WiFi sensing operation.

Referring to FIG. 3, the method 100 for coordinating operation of the wireless communication network 26 of FIG. 2, in this case a WiFi network aboard the host system 10 of FIG. 1 having one or more wireless sensors, may be implemented to enable the selective prioritization of sensing traffic within the host system 10. The method 100, which may be performed via the WCS 25/CC_{O} node of FIGS. 1 and 2, is illustrated in discrete code segments or logic blocks. Each logic block may be embodied as computer-readable instructions recorded in the memory 24 and executed/read by the processor 22.

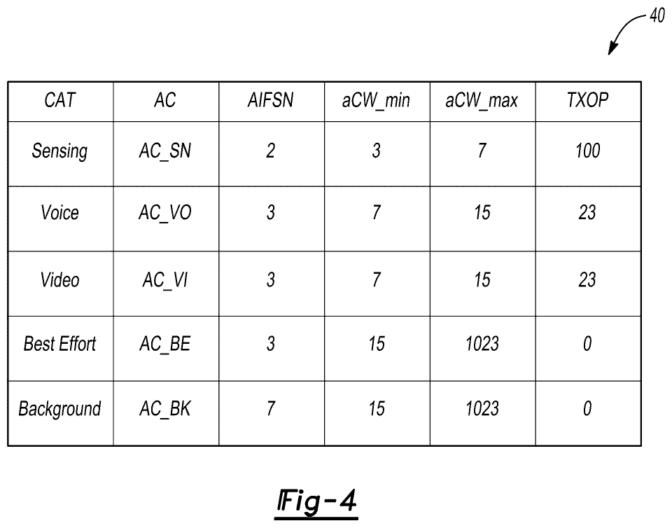

Beginning with block B102, the method 100 includes detecting wireless traffic (as detected WiFi traffic in this exemplary embodiment) between WiFi nodes 28 on one or more channels of the wireless communication network 26. This occurs using the WCS 25/central coordinator (CC_{O}) node of the wireless communication network 26 in some implementations, and includes identifying the WiFi traffic type via the WCS 25. As shown in table 40 of FIG. 4, WiFi sensing is assigned to a new access category herein, e.g., AC_SN, with AC representing “access category” and “SN” representing “sensing”. This category is in addition to the existing ACs of voice (AC_VO), video (AC_VI), best effort (AC_BE), and background (AC_BK). The specific notation may vary from “AC_SN”, as will be appreciated in the art, e.g., “AC_SG” or another suitable designation. Thus, AC_SN is used herein solely for illustration.

Received WiFi traffic within the wireless communication network 26 of FIG. 2 may include a bit string or another value indicative of the traffic belonging to the AC_SN category. The method 100 proceeds to block B104 once the access category has been identified by the WCS 25/CC_{O} node.

At block B104, the method 100 of FIG. 2 next determines if the access category (AC) identified in block B102 is the sensing category, i.e., AC_SN of FIG. 4. That is, the method 100 at block B104 includes identifying the AC of the detected WiFi traffic, via the WCS 25/CC_{O} node (or the tasks may be distributed in other embodiments), as corresponding to sensing traffic, i.e., wireless sensing operations or a sensing round of the one or more wireless (WiFi or WiFi-enabled) sensors amongst the WiFi nodes 28 of FIG. 2. The method 100 proceeds to block B105 when the sensing category is not identified at block B102, i.e., when one of the four other QoS access categories is identified. The method 100 proceeds in the alternative to block B106 when the sensing category (AC_SN) is identified.

Block B105 entails performing WiFi traffic processing via the WCS 25 without change to existing QoS parameters. That is, voice (AC_VO) retains the highest priority and shortest contention window (CW), followed in reduced order of priority by video (AC_VI), best effort (AC_BE), and background (AC_BK). Video (AC_VI), best effort (AC_BE), and background (AC_BK) are assigned progressively increased CW. The method 100 thereafter returns to block B102.

Block B106 includes adapting, modifying, or otherwise adjusting existing QoS parameters to WiFi sensing requirements. The “existing QoS parameters” are the default parameters executed at block B105, i.e., the priorities and CW assignments corresponding to unmodified 802.11. As part of block B106, the WCS 25 of FIGS. 1 and 2 may set a logic bit indicating that the existing/default QoS parameters will be modified before proceeding to blocks B108A, B108B, B108C, and B108D in the illustrative embodiment of FIG. 3. As part of block B106, the WCS 25 assigns a higher priority to the sensing traffic relative to other wireless traffic on the one or more channels of the wireless communication network 26 (FIG. 2).

WiFi Sensing-based QoS Parameters: Blocks B108A-D respectively describe different prioritizing control actions that may be performed by the WCS 25/CC_{O} node when the detected WiFi traffic is sensing traffic, with such actions collectively assigning a higher priority to the sensing traffic relative to other wireless traffic on the one or more channels of the wireless/WiFi communication network 26. Shown as four parallel or concurrent blocks in FIG. 3, the various modifications may vary with the application, with more or fewer actions possibly being taken in other implementations. Each of the representative blocks B108A-D may be understood with reference to the exemplary data of table 40 as shown in FIG. 4.

At block B108A (“Adapt AIFSN”), the WCS 25/CC_{O} node may adapt or modify the arbitrary inter-frame space number (AIFSN) for the detected WiFi traffic, including at least prioritizing the sensing traffic. As appreciated in the art, AIFSN is a parameter used for QoS under IEEE 802.11e to determine a length of an Arbitration Inter-Frame Space (AIFS). AIFS for its part is a defined waiting period before a station in the wireless communication network 26 of FIG. 2 is permitted to transmit data or attempt to access a WiFi channel. In general, the different access categories noted above are assigned different AIFSN values, with lower AIFSN values assigned to higher priority WiFi traffic, i.e., stations having a lower AIFSN will be permitted by the WCS 25 to attempt a WiFi transmission sooner.

Block B108A may therefore entail assigning a lower AIFSN value to WiFi sensing traffic, i.e., the sensing category AC_SN of FIG. 4, relative to the remaining categories AC_VO, AC_VI, AC_BE, and AC_BG. In the non-limiting example data presented in table 40 of FIG. 4, for instance, the WiFi sensing category is assigned an AIFSN of 2, which is the lowest of the AIFSNs in table 40.

At block B108B (“Adapt Min/Max Contention Window”) of FIG. 3, the WCS 25/CC_{O} node may also adapt or modify the contention window (CW) for the detected WiFi traffic, including prioritizing the sensing traffic as noted above. The CW according to IEEE 802.11 is a component of the medium access control (MAC) mechanism that is used to coordinate access to available WiFi channels when multiple stations attempt to simultaneously transmit data. More specifically, CWs are “backoff times” defined by time slots or windows that a given station is required to wait before attempting a transmission.

As shown in FIG. 4, the size of the CW is defined by a minimum and maximum, i.e., aCW_min and aCW_max. For the new access category AC_SN of FIG. 4, for instance, a minimum of 3 and a maximum of 78 may be assigned, i.e., values lower than those used in the remaining four QoS categories. For each category, the backoff time is determined as the sum of the AIFSN (block B108A) and a random value between 0 and the CW size, or between 0 and 4 in the example of FIG. 4. In general, smaller CW values provide higher throughput, but at the expense of increased collision probability, while larger CW values conversely reduce the risk of collision with an increased delay.

Block B108C (“Adapt TXOP”) includes adapting or modifying the transmit opportunity (TXOP) for the detected WiFi traffic, including prioritizing the sensing traffic. TXOP refers to the time interval during which a given station or WiFi node 28 in the wireless communication network 26 of FIG. 1 has the right to initiate frame exchange sequences onto the wireless medium. A station is allowed to transmit multiple data frames continuously within the allotted TXOP time limit without having to recontend for the channel, thus allowing multiple frame transmissions in a single channel access. QoS-sensitive applications are thus provided with a sensing availability window (SAW) having longer TXOP limits and more predictable access times. In FIG. 4, for instance, the TXOP is shown as being higher for the new access class (AC_SN) corresponding to WiFi sensing, in this exemplary instance 100 (in 32 us units) versus 23 for voice and video, and 0 for best effort and background. As appreciated in the art, TXOP=0 means that, at the network layer, just one packet of data (regardless of its length) may be transmitted per TXOP. Background and best effort categories have a TXOP limit of 0, i.e., they do not use TXOP, but rather send just one MAC service data unit (MSDU) before having to contend again for channel access. ACs with higher TXOP limits in FIG. 4 in contrast are able to send as many frames as possible within the TXOP limit.

Block B108D (“Adapt RTS/CTS”) includes leveraging or adapting the request-to-send (RTS)/clear-to-send (CTS) mechanism provided for in IEEE 802.11 to help reduce frame collisions and address the hidden node problem, i.e., when two stations/nodes 28 cannot detect each other's transmissions but can still interfere/collide at a common receiving station. As appreciated in the art, a transmitting station may send an RTS frame, which includes information pertaining to frame control, duration/ID, receiver address (RA), transmitter address (TA), and frame check sequence (FCS). A receiving station then responds with a CTS frame if the requested medium is available, in this case omitting the transmitter address (TA). The sending station transmits its data frame after receiving the CTS, with the receiving station thereafter sending an acknowledgement (ACK) to confirm receipt. The RTS threshold determines the size of the data frame at which the RTS/CTS is triggered.

Specifically, it defines the minimum frame size to be used to initiate an RTS/CTS exchange. When one of the nodes 28 of FIG. 2 wishes to send a frame, the frame is sent when the frame size exceeds the RTS threshold. When smaller than the threshold, the RTS/CTS mechanism is skipped and the data frame is sent directly to a receiving node. Therefore, the existing RTS/CTS mechanism—i.e., how RTS/CTS currently operates under the relevant standard-assists in enabling implementations of the present solutions, i.e., when WiFi sensing traffic comes in and is afforded the highest priority, other devices are informed of the actions a node is going to take using the channel for a particular amount of time. Leveraging existing RTS/CTS capabilities thus informs other nodes not to use the channel in question.

The duration of RTS and CTS frames may be determined mathematically as part of the WiFi communication process using the Short Interframe Space (SIFS) timing parameter, which is the fixed interval between transmission of certain frame sequences providing a short delay between frames. Using SIFS, a responding station is able to send an ACK or CTS frame before other stations are allowed to begin transmission. RTS Duration is the sum of (SIFS+CTS transmission time)+ (SIFS+Data Frame Transmission Time)+ (SIFS+ACK Frame Transmission Time). CTS Duration is the sum of (SIFS+Data Frame Transmission Time)+ (SIFS+ACK Frame Transmission Time). In essence, the RTS Duration field noted above sets the entire reservation time, including the CTS frame, while CTS Duration Field specifies the remaining reservation time for the data and acknowledgement frames. Thus, when WiFi traffic comes in, the traffic identifies its duration of transmission through the above-summarized duration fields. This helps other devices in the network 28 of FIG. 2 to determine the length of time that they are required to defer transmissions so as to avoid collisions on a channel.

As part of block B108D, RTS/CTS thresholds may be lowered by the WCS 25 if WiFi sensing traffic involves small data frames. This will force more frames to use RTS/CTS, thus helping to manage collisions and prioritize WiFi sensing traffic. The RTS threshold is configurable on many wireless routers and APs, and is often set to a value that balances network performance with overhead. Within the scope of the disclosure, the WCS 25 using method 100 may modify the RTS/CTS thresholds to tell other connected devices how long a channel will be busy handling WiFi sensing traffic. Thus, the WCS 25/CC_{O} node is configured to assign a higher priority to WiFi sensing traffic relative to other wireless traffic on the one or more channels of the wireless communication network 26 of FIG. 2 and thereafter coordinate network communication between the plurality of WiFi nodes 28 in accordance with the higher priority.

Various implementations are possible in view of the above teachings. For instance, in an example adaptation the WCS 25/CC_{O} node of FIGS. 1 and 2 may reprioritize the QoS parameters of different types of WiFi traffic into two modes: (1) normal mode, in which there is no detected WiFi sensing and an existing QoS profile is used for other access classifications, i.e., with voice highest in priority, followed by video, best effort, and background as described above. However, during WiFi sensing as determined at block B104 of FIG. 3, the WCS 25/CC_{O} node may assign the highest QoS profile for sensing traffic, with the remaining access classes assigned to the lowest priority, i.e., background. This may entail assigning existing default parameters for voice, i.e., AC_VO of FIG. 4, to the new WiFi sensing class, and then flagging the remaining four accessor categories as background until the WiFi sensing is complete.

In another approach, the WCS 25/CC_{O} node may reprioritize QoS parameters in a different manner. Absent WiFi sensing, existing/default priorities may be used for voice, video, best effort, and background. However, when in WiFi sensing mode, the highest QoS profile may be set for WiFi sensing traffic, with the WCS 25/CC_{O} node adapting the QoS profiles for the remaining access categories. In this instance, the four non-sensing categories may retain unique profiles rather than being treated as lowest priority background as in the prior example. As shown in FIG. 4, for instance, the channel access priority for voice and video traffic may be lowered to that of best effort while increasing backoff time and reducing TXOP relative to the new WiFi sensing category.

In yet another approach, the WCS 25/CC_{O} node may weigh according to a number of WiFi devices used in the wireless communications network 26 of FIG. 2. Given that each AP knows how many devices it is connected to, the traffic pattern, and the traffic type, the AP may also determine the type of traffic occurring between devices that are not connected to it, such as through historical data. The AP may then weigh parameters for different traffic differently according to the amount of connection after incorporating the number of devices and traffic type. For example, the host system 10 of FIG. 1 may have several occupants using voice, video, and internet streaming. WiFi sensing traffic when present may trigger the WCS 25/CC_{O} node to determine the number of users present in the wireless communication network 26, and then increase aCW_min, aCW_max, and AIFSN in proportion to the number of users. Using representative values, for instance, aCW_min and aCW_max may be increased to 15 and 63 for five voice users, or to 31 and 127 for ten voice users, such that twice as many users results in twice the aCW_min and aCW_max values. In a possible implementation, a graph or lookup table may be stored in memory 24 of FIG. 1 and accessed in real time by the WCS 25, with the WCS 25 extracting the corresponding values and implementing them when WiFi sensing traffic is present.

Using the forgoing teachings, it is possible to differentiate WiFi sensing traffic from other WiFi traffic, and to selectively prioritize the WiFi sensing traffic over competing WiFi communications for available spectrum in the vehicle 11 or other host system 10. This enables coordinating of network communication between the WiFi nodes in accordance with the higher priority. In this manner, the WCS 25/CC_{O} node is able to ensure that sensing traffic is afforded the greatest opportunity to access a channel compared to other traffic, with sufficient time to transmit on the channel when needed. As part of the disclosed solutions, a new access channel dedicated solely to WiFi sensing traffic may be introduced into prevailing standards, principally IEEE 802.11 as noted above. Using the present teachings, WiFi sensing, particularly as it relates to predetermined important functions such as occupant detection, is able to be performed quickly and reliably within the fast response times often required, for instance when sensing the presence of children, pets, or other potentially vulnerable occupants who may remain inside of the vehicle after an operator has exited the vehicle 11.

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, “any” and “all” shall both mean “any and all”, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A method for coordinating operation of a WiFi communication network aboard a host system having one or more wireless sensors, the one or more wireless sensors including WiFi sensors and/or WiFi-enabled sensors, the method comprising:
detecting, as detected WiFi traffic using a central coordinator (CC_{O}) node of the WiFi communication network, wireless traffic between a plurality of WiFi nodes on one or more channels of the WiFi communication network, the plurality of WiFi nodes including the one or more wireless sensors;
identifying an access category (AC) of the detected WiFi traffic as corresponding to sensing traffic, the sensing traffic including wireless sensing operations of the one or more wireless sensors;
assigning a higher priority to the sensing traffic relative to other wireless traffic on the one or more channels of the WiFi communication network; and
coordinating network communication between the plurality of WiFi nodes in accordance with the higher priority.

2. The method of claim 1, wherein assigning the higher priority to the sensing traffic relative to other wireless traffic includes adapting or modifying one or more Quality of Service (QoS) parameters of at least the sensing traffic.

3. The method of claim 2, wherein adapting or modifying the one or more QoS parameters includes adapting or modifying an arbitrary inter-frame space number (AIFSN).

4. The method of claim 2, wherein adapting or modifying the one or more QoS parameters includes adapting or modifying a contention window (CW) size.

5. The method of claim 2, wherein adapting or modifying the one or more QoS parameters includes adapting or modifying a transmit opportunity (TXOP) value.

6. The method of claim 2, wherein adapting or modifying the one or more QoS parameters includes adapting or modifying a respective threshold of a request-to-send (RTS) frame and a clear-to-send (CTS) frame.

7. The method of claim 2, wherein assigning the higher priority to the sensing traffic relative to other wireless traffic on the one or more channels includes lowering a communication priority of one or more of voice traffic, video traffic, best effort traffic, or background traffic.

8. The method of claim 7, wherein lowering the communication priority of one or more of the voice traffic, video traffic, best effort traffic, or background traffic includes assigning a priority to the voice traffic, the video traffic, and the best effort traffic to match a priority level of the background traffic.

9. The method of claim 1, wherein assigning the higher priority to the WiFi sensing traffic relative to other wireless traffic on the one or more channels is based at least in part on a number of devices that are using the WiFi communication network.

10. The method of claim 9, further comprising:
adjusting one or more Quality of Service (QoS) parameters in proportion to the number of devices that are using the WiFi communication network.

11. The method of claim 1, wherein identifying the AC of the detected WiFi traffic includes detecting one or more bits in the detected WiFi traffic that correspond to the AC.

12. The method of claim 1, further comprising:
sensing a value in the host system, as a sensed value, using the one or more WiFi sensors; and
transmitting the sensed value to the CC_{O} node as part of the WiFi sensing operation.

13. A WiFi communication network, comprising:
a plurality of WiFi nodes operable for generating wireless communication traffic, the WiFi nodes including at least one wireless sensor, the at least one wireless sensor including a WiFi sensor and/or a WiFi-enabled sensor; and
a central coordinator (CC_{O}) node in wireless communication with each respective one of the WiFi nodes, wherein the CC_{O} node is configured to:
detect the wireless traffic on one or more channels of the WiFi communication network as detected WiFi traffic;
identify a Quality of Service (QoS) access category (AC) of the detected WiFi traffic as corresponding to sensing traffic from the at least one wireless sensor, the sensing traffic corresponding to WiFi sensing operations of one or more of the WiFi nodes;
assign a higher priority to the sensing traffic relative to other wireless traffic on the one or more channels; and
coordinate WiFi communication between the plurality of WiFi nodes in accordance with the higher priority.

14. The WiFi communication network of claim 13, wherein the CC_{O} node is configured to assign the higher priority to the sensing traffic relative to other wireless traffic on the one or more channels by adapting or modifying one or more QoS parameters of the WiFi sensing traffic.

15. The WiFi communication network of claim 14, wherein adapting or modifying the one or more QoS parameters includes adapting or modifying an arbitrary inter-frame space number (AIFSN) for the detected WiFi sensing traffic, a contention window (CW) size for the detected WiFi sensing traffic, a transmit opportunity (TXOP) value for the detected WiFi sensing traffic, and a respective threshold of a request-to-send (RTS) frame and a clear-to-send (CTS) frame.

16. The WiFi communication network of claim 13, wherein the CC_{O} node is configured to assign the higher priority to the WiFi sensing traffic relative to other wireless traffic on the one or more channels by lowering a communication priority of one or more of: voice traffic, video traffic, best effort traffic, or background traffic.

17. The WiFi communication network of claim 16, wherein lowering the communication priority of one or more of the voice traffic, video traffic, best effort traffic, or background traffic includes assigning a priority to the voice traffic, the video traffic, and the best effort traffic to match a priority level of the background traffic.

18. The WiFi communication network of claim 13, wherein the CC_{O} node is configured to assign the higher priority to the WiFi sensing traffic relative to other wireless traffic on the one or more channels based at least in part on a number of devices using the WiFi communication network, including by adjusting one or more QoS parameters in proportion to the number of the WiFi nodes using the WiFi communication network.

19. A vehicle comprising:
a vehicle body;
a set of road wheels connected to the vehicle body;
a propulsion system connected to one or more of the road wheels; and
a WiFi communication network, including:
a plurality of WiFi nodes operable for generating wireless traffic, the WiFi nodes including at least one wireless sensor, the at least one wireless sensor including a WiFi sensor and/or a WiFi-enabled sensor; and
a central coordinator (CC_{O}) node in wireless communication with each respective one of the WiFi nodes, wherein the CC_{O} node is configured to:
detect the wireless traffic on one or more channels of the WiFi communication network as detected WiFi traffic;
identify a Quality of Service (QoS) access category (AC) of the detected WiFi traffic as corresponding to sensing traffic from the at least one wireless sensor, the sensing traffic corresponding to WiFi sensing operations of one or more of the WiFi nodes;
assign a higher priority to the sensing traffic relative to other wireless traffic on the one or more channels by adapting or modifying one or more QoS parameters of the sensing traffic, the QoS parameters including an arbitrary inter-frame space number (AIFSN), a contention window (CW) size, a transmit opportunity (TXOP) value, and a respective threshold of a request-to-send (RTS) frame and a clear-to-send (CTS) frame; and
coordinate network communication between the plurality of WiFi nodes in accordance with the higher priority.

20. The vehicle of claim 19, wherein the CC_{O} node is configured to:
determine a number of the WiFi nodes using the WiFi communication network; and
assign the higher priority to the sensing traffic relative to other wireless traffic on the one or more channels based at least in part on a number of WiFi nodes using the WiFi communication network, including by adjusting one or more QoS parameters in proportion to the number of devices using the WiFi communication network.
